(19) United States
(12) Patent Application Publication
(10) Pub. No.: US 2016/0050132 A1
(43) Pub. Date: Feb. 18, 2016

(54) METHOD AND SYSTEM TO DYNAMICALLY COLLECT STATISTICS OF TRAFFIC FLOWS IN A SOFTWARE-DEFINED NETWORKING (SDN) SYSTEM

(71) Applicant: Telefonaktiebolaget L M Ericsson (publ), Stockholm (SE)

(72) Inventor: Ying Zhang, Fremont, CA (US)

(21) Appl. No.: 14/462,444

(22) Filed: Aug. 18, 2014

(51) Int. Cl. H04L 12/26

(52) U.S. Cl. CPC H04L 43/0876; H04L 43/16

(57) ABSTRACT

Methods implemented in an electronic device are disclosed for dynamically collecting traffic flow in a SDN system. For each of a plurality of sets of traffic flows, the method causes a monitor to be configured to collect traffic statistics. The monitors are instructed to collect traffic statistics, and the traffic statistics are received. For each monitor, the method determines if the received traffic statistics are within a set of acceptable limits or not, wherein the set of acceptable limits includes one or more of an upper bound and a lower bound. For each of the sets of traffic flows of which the received traffic statistics were determined outside of the acceptable limits, the method causes a change of increase or decrease of collection of the traffic statistics of the traffic flows.

### FIELD OF INVENTION

The embodiments of the invention are related to the field of networking. More specifically, the embodiments of the invention relate to a method and system to dynamically collect statistics of traffic flows in a network, particularly a software-defined networking (SDN) system.

### BACKGROUND

In a data or computing network, traffic statistics collection is critical to many network management applications, ranging from network planning, routing optimization, customer accounting, and anomaly detection. In a typical network, statistics of traffic are reported by routers/switches to a centralized management system. The network measurement generates additional traffic and compete with data traffic of the network for resources. As a result, an aggressive monitoring may result in artificial bottlenecks in the network; yet, with too passive a monitoring scheme, it may miss important events and the management system cannot react promptly. Thus an operator of the network needs to strike a careful balance between effectiveness (supporting a wide range of applications with accurate statistics) and efficiency (introducing low overhead and cost).

In order to achieve the careful balance, it is desirable to dynamically collect traffic statistics in a network. In other words, it is better to collect more traffic statistics when the network shows certain symptoms of abnormal behavior, and collect less traffic statistics when the network operates normally. Prior art has disclosed ways to dynamically detect traffic anomalies in a network. See for example, U.S. patent application Ser. No. 13/872,855 by Ying Zhang, entitled “A Method and System to Dynamically Detect Traffic Anomalies in a Network.”

SDN as a network architecture has gain significant interests in networking industry. A SDN system offers programmability, centralized intelligence, and abstractions from the underlying network infrastructure. Data traffic is generally managed as traffic flows in a SDN system. It is advantageous to dynamically collect traffic statistics of traffic flows in a SDN system.

### SUMMARY

A method implemented in an electronic device serving as a software-defined network (SDN) controller in a network containing network elements is disclosed. Through the network, traffic flows are transmitted by the network elements. The method comprises: for each of a plurality of sets of traffic flows, causing a monitor to be configured on an identified network element to collect traffic statistics for that set of traffic flows, where at least some of the sets of traffic flows include two or more traffic flows that form a traffic aggregate. The method continues with instructing the monitors configured on the network elements to collect traffic statistics and receiving the traffic statistics from the monitors. For each monitor, the method continues with determining if the received traffic statistics from the monitor are within a set of acceptable limits or not, where the set of acceptable limits includes one or more of an upper bound and a lower bound. For each of the sets of traffic flows of which the received traffic statistics were determined to be outside of its set of acceptable limits, the method continues with causing a change in the collection of the traffic statistics for that set of traffic flows, where the change is an increase when the upper bound is included and the received traffic statistics are higher than the upper bound, and where the change is a reduction when the lower bound is included and the received traffic statistics are lower than the lower bound.

An electronic device serving as a software-defined network (SDN) controller coupled to a network containing network elements is disclosed. Through the network, traffic flows are transmitted by the network elements. The electronic device comprises a processor and a non-transitory machine-readable storage medium coupled to the processor, the non-transitory machine-readable storage medium containing instructions executable by the processor. The electronic device is operative to: for each of a plurality of sets of traffic flows, cause a monitor to be configured on an identified network element to collect traffic statistics for that set of traffic flows, where at least some of the sets of traffic flows include two or more traffic flows that form a traffic aggregate. The electronic device is also operative to instruct the monitors configured on the network devices to collect traffic statistics and receive the traffic statistics from the monitors. For each monitor, the electronic device is also operative to determine if the received traffic statistics from the monitor are within a set of acceptable limits or not, where the set of acceptable limits includes one or more of an upper bound and a lower bound. For each of the sets of traffic flows of which the received traffic statistics were determined to be outside of its set of acceptable limits, the electronic device is further operative to cause a change in the collection of the traffic statistics for that set of traffic flows, where the change is an increase when the upper bound is included and the received traffic statistics are higher than the upper bound, and where the change is a reduction when the lower bound is included and the received traffic statistics are lower than the lower bound.

A non-transitory machine-readable storage medium having instructions stored therein for dynamical traffic statistics collection is disclosed. The non-transitory machine-readable storage medium, when executed by a processor, causes the processor to perform operations implemented in an electronic device serving as a software-defined network (SDN) controller in a network containing network elements. The operations includes for each of a plurality of sets of traffic flows, causing (202) a monitor to be configured on an identified network element to collect traffic statistics for that set of traffic flows, where at least some of the sets of traffic flows include two or more traffic flows that form a traffic aggregate. The operations continue with instructing the monitors configured on the network elements to collect traffic statistics and receiving the traffic statistics from the monitors. For each monitor, the operations continue with determining if the received traffic statistics from the monitor are within a set of acceptable limits or not, where the set of acceptable limits includes one or more of an upper bound and a lower bound. For each of the sets of traffic flows of which the received traffic statistics were determined to be outside of its set of acceptable limits, the operations continue with causing a change in the collection of the traffic statistics for that set of traffic flows, where the change is an increase when the upper bound is included and the received traffic statistics are higher than the upper bound, and where the change is a reduction when the lower bound is included and the received traffic statistics are lower than the lower bound

Embodiments of the invention provide ways for a SDN controller to dynamically collect traffic statistics based on received traffic statistics, and the collection offers both effectiveness and efficiency in traffic monitoring.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this specification are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1A illustrates an architecture for dynamically collect traffic statistics in a SDN system according to one embodiment of the invention.

FIG. 1B illustrates monitoring traffic flows according to one embodiment of the invention.

FIG. 2 is a flow diagram illustrating a method for dynamically collect traffic statistics in a SDN system according to one embodiment of the invention.

FIG. 3 is a pseudo code program illustrating an algorithm for placing monitors to network elements according one embodiment of the invention.

FIGS. 4A-D illustrates an example of monitor placement according to one embodiment of the invention.

FIG. 5 is a flow diagram illustrating a method of monitor placement according to one embodiment of the invention.

FIG. 6 is a flow diagram illustrating determination of whether or not the received traffic statistics are within the acceptable limits according to one embodiment of the invention.

FIG. 7 is a flow diagram illustrating a method of zoom-in of collection of traffic statistics according to one embodiment of the invention.

FIG. 8 is a flow diagram illustrating a method of zoom-out of collection of traffic statistics according to one embodiment of the invention.

FIG. 9 is a pseudo code program illustrating an algorithm for dynamically collecting statistics of traffic flows according one embodiment of the invention.

FIG. 10A illustrates connectivity between network devices (NDs) within an exemplary network, as well as three exemplary implementations of the NDs, according to some embodiments of the invention.

FIG. 10B illustrates an exemplary way to implement the special-purpose network device 1002 according to some embodiments of the invention.

FIG. 10C illustrates various exemplary ways in which virtual network elements (VNEs) may be coupled according to some embodiments of the invention.

FIG. 10D illustrates a network with a single network element (NE) on each of the NDs of FIG. 10A, and a centralized approach for maintaining reachability and forwarding information (also called network control), according to some embodiments of the invention.

FIG. 10E illustrates the simple case of where each of the NDs 1000A-H implements a single NE 1070A-H (see FIG. 10D), but the centralized control plane 1076 has abstracted multiple of the NEs in different NDs (the NEs 1070A-C and G-H) into (to represent) a single NE 1070I in one of the virtual network(s) 1092 of FIG. 10D, according to some embodiments of the invention.

FIG. 10F illustrates a case where multiple VNEs (VNE 1070A.1 and VNE 1070H.1) are implemented on different NDs (ND 1000A and ND 1000H) and are coupled to each other, and where the centralized control plane 1076 has abstracted these multiple VNEs such that they appear as a single VNE 1070T within one of the virtual networks 1092 of FIG. 10D, according to some embodiments of the invention.

FIG. 11 illustrates a general purpose control plane device 1104 including hardware 1140 comprising a set of one or more processor(s) 1142 (which are often Commercial off-the-shelf (COTS) processors) and network interface controller(s) 1144 (NICs; also known as network interface cards) (which include physical NIs 1146), as well as non-transitory machine readable storage media 1148 having stored therein centralized control plane (CCP) software 1150), according to some embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

Architecture to Dynamically Collect Traffic Statistics

Existing traffic monitoring solutions are usually deployed as a separate box in the network, gathering the network states and traffic statistics using traffic tapping and/or collecting traffic statistics as traffic enters or exits an interface. The data collected and stored are for postmortem analysis. The main challenge of this way of collecting traffic statistics is the overhead of the traffic measurement and the accuracy for the measurement tasks. In the past, the dominance means to achieve this balance is traffic sampling, i.e., a router selectively records packets or flows uniformly at random with a pre-configured sampling rate. The thinned traffic is then fed as input to the network-monitoring task. While being attractive as they are simple to implement with low CPU power and memory requirements, extensive research has shown it to be inaccurate, as small flows are likely to be missed entirely.

In the traditional architecture where control plane and forwarding plane are integrated, the network elements usually are coupled with a smart control plane in the same physical box. Therefore, some complex computations can be carried out locally within the box. However, since many SDN architectures employ low-end commodity switches as the network elements to forward traffic, we cannot assume that network elements support complex functionalities. Thus, the measurement framework of the present invention is designed only to rely on the simple match-and-count rules installed for traffic statistics collection at the network element and the operations of traffic statistics collection are adjusted by the controller.

The embodiments of the invention are built upon the SDN concept. SDN has a centralized network controller that manages all the network elements with the full knowledge of routing path and switch/forwarding capacity. Thus, it enables centralized logical decisions to be imposed and carried out easily. Two key features of SDN are utilized in the embodiments of the invention. One key feature is that SDN breaks the tight bindings between forwarding and traffic statistics collection. One may install monitors based on wildcard rules on network elements for traffic statistics collection differently from rules for packet forwarding on the network elements. That offers flexibility in defining the set of traffic flows to monitor traffic statistics. The other key feature is that thanks to the simple interface between control and forwarding planes, one can adjust monitoring easily but causing changes in the collecting traffic statistics at the monitors configured to the network elements. The adjustment makes real-time dynamic traffic statistics collection practical.

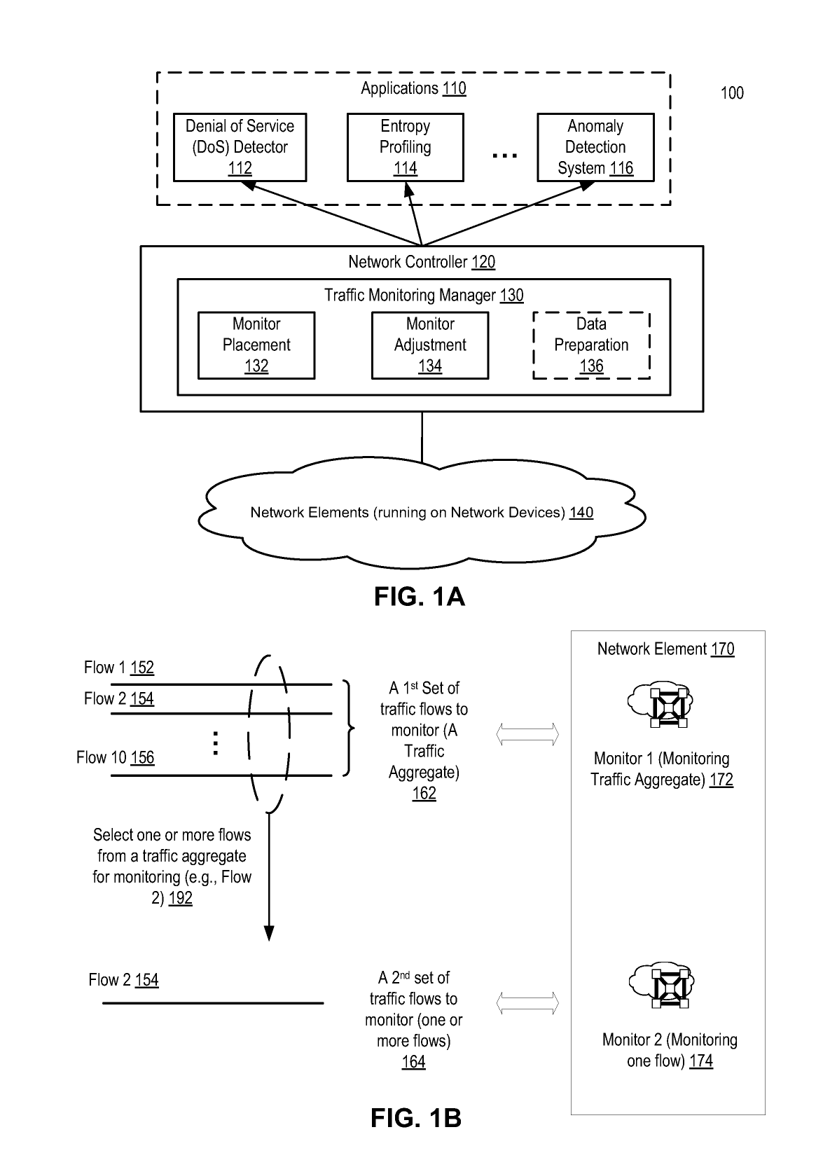

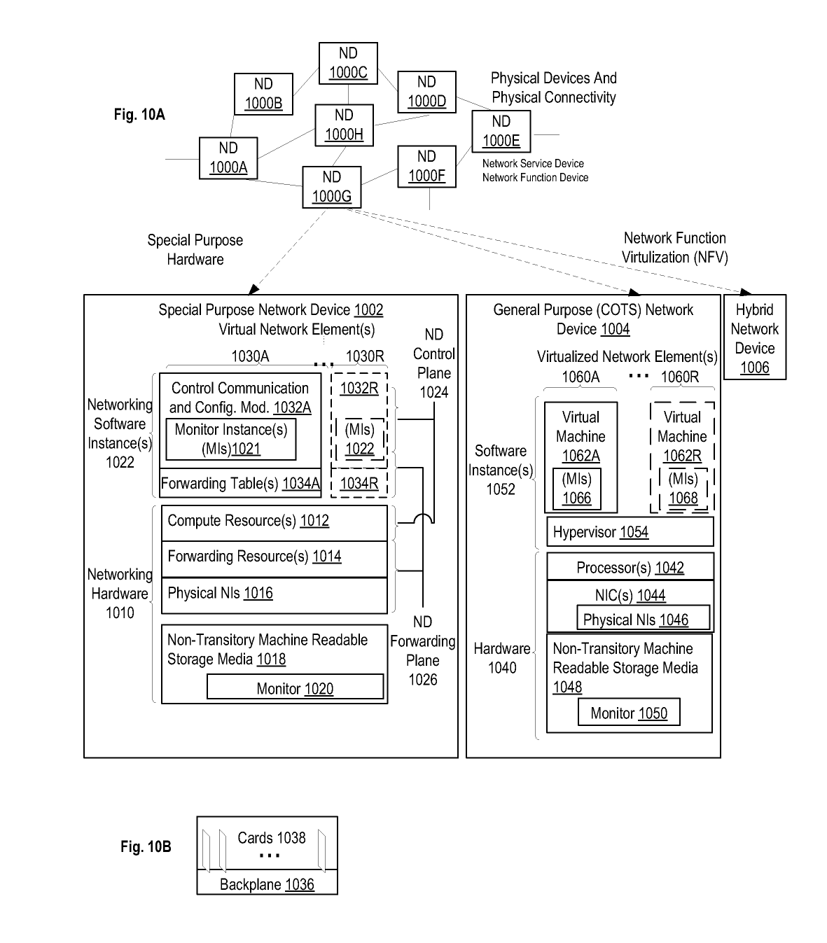

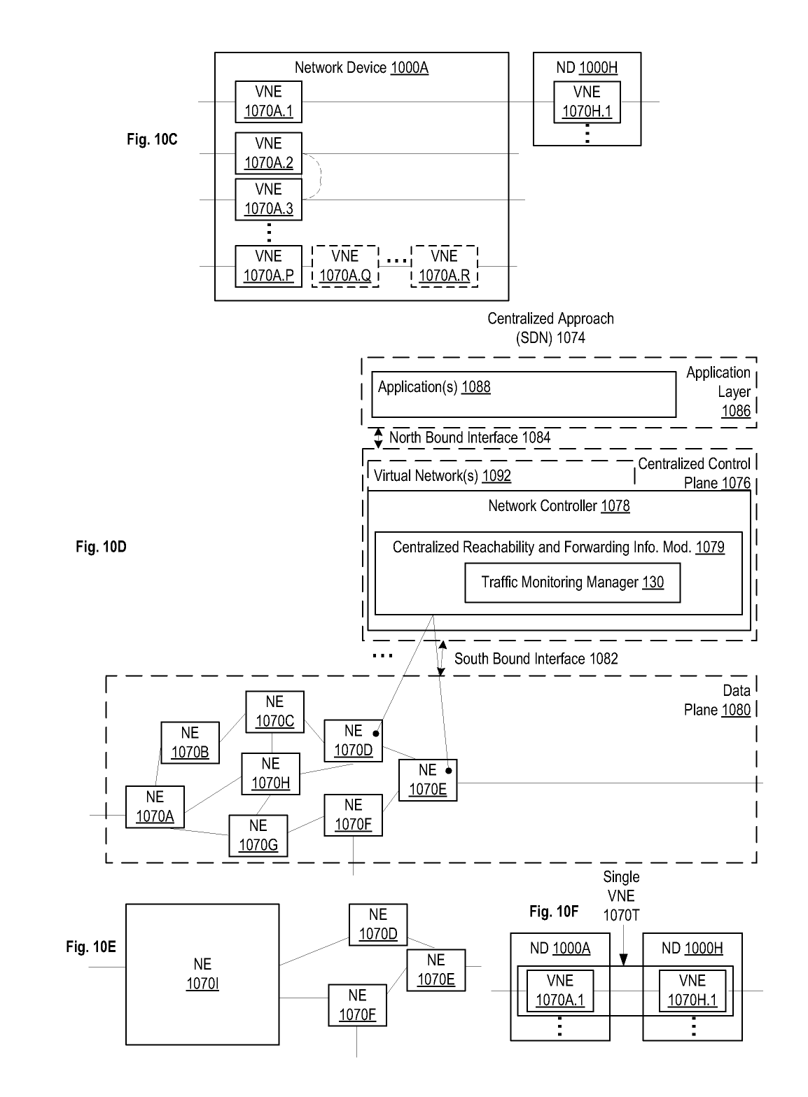

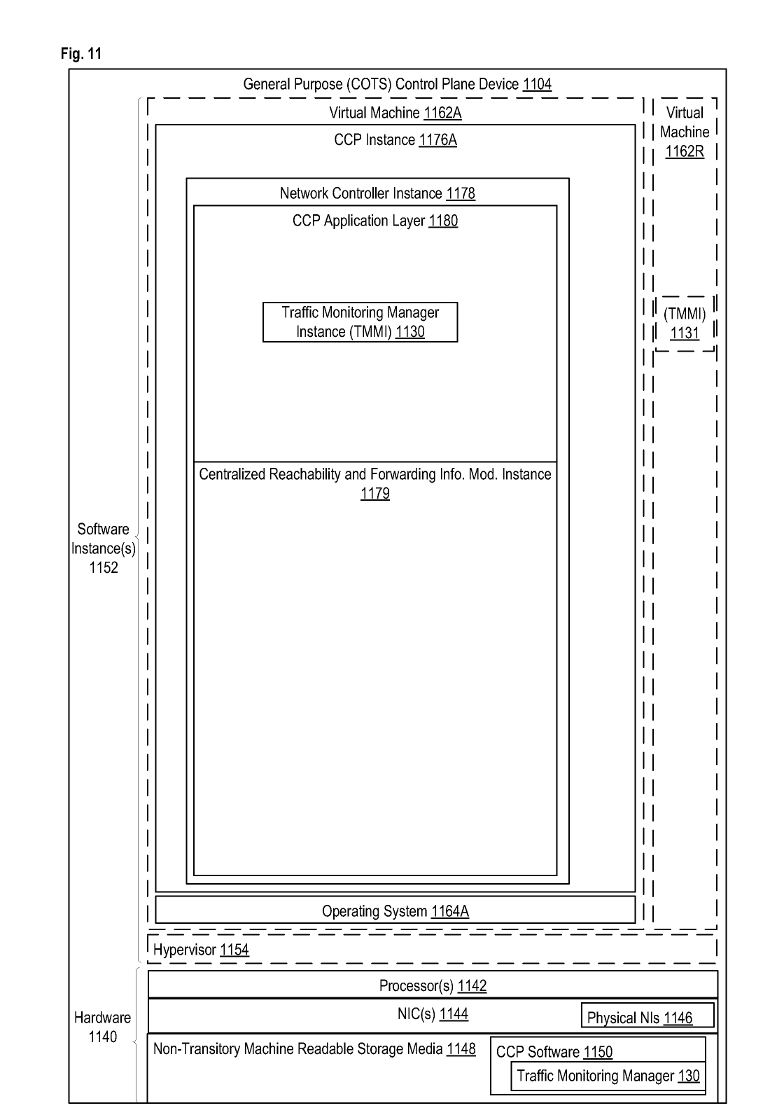

FIG. 1A illustrates architecture for dynamically collecting traffic statistics in a SDN system according to one embodiment of the invention. SDN system 100 contains network elements running on network devices at reference 140. The network elements are managed by network controller 120, which interacts with applications 110. The functionalities of network elements, network controller, and applications are detailed herein below in FIGS. 10A-10F and FIG. 11. Traffic monitoring manager 120 is a function resides in network controller 120 and performs operations for dynamically collecting traffic statistics.

For traffic statistics collection, monitors are configured to network elements. Monitors may be software functions or hardware modules implemented on the network elements and through instantiation, the monitors performing the traffic statistics collection. The monitors collect statistics of traffic flows transmitted through the network. The collection of traffic flow statistics is also referred to as flow counting and the monitors are referred to as counters as the collection often involves counting packets within flows, such as numbers of total packets, dropped packets, and error packets in a given period. However, the embodiments of the invention applies to monitoring traffic statistics beyond only counting packets. For example, a monitor may be configured to monitor resource usage in a network element by a traffic flow, congestion level at the network element with regard to the traffic flow, and etc.

Traffic monitoring manager 120 contains three components: monitor placement 132, monitor adjustment 134 and data preparation 136. The three components each perform a distinct function, although they may be implemented in one or more integrated entities in some embodiments.

Monitor placement 132 is to intelligently configure monitors to various network elements so that the tasks of traffic statistics collection are not heavily allocated on each individual network element, rather, the monitors are distributed to reduce impact on each network element.

The monitors then collect traffic statistics of traffic flows, and the collected traffic statistics are received at traffic monitoring manager 120. Traffic monitoring manager 120 then utilizes monitor adjustment 134 to adjust traffic monitoring. Specifically, monitor adjustment 134 determines if the received traffic statistics from a monitor are within a set of acceptable limits or not. If the received traffic statistics are within the set of acceptable limits, the monitor continues current collection. If the received traffic statistics from the monitor is outside of the set of acceptable limits, monitor adjustment 134 causes a change of the collection of the traffic statistics of the monitored traffic flows. The change may be an increase of collecting of the traffic statistics when an issue is spotted in the monitored traffic flow to pinpoint the root cause or a decrease of collecting of the traffic statistics when the monitored traffic flows are transmitted smoothly and the decrease reduces consumption of network resources due to monitoring.

The change causes updated traffic statistics to be received at traffic monitoring manager 130. Traffic monitoring manager 130 then utilizes data preparation 136 to normalize the received traffic statistics. With monitoring adjustment, traffic statistics are collected differently for different traffic flows, for applications to utilize/analyze the collected traffic statistics properly, it is desirable to normalize the collected traffic statistics so that the applications gets comparable traffic statistics of different traffic flows.

The collected traffic statistics are then forwarded to applications 110, which may include a variety of applications. For example, application 110 may include denial of service (DoS) detector 112 to determine whether or not a DoS attack is occurring. It may also include entropy profiling 114 to determine security attacks and anomaly detection system 116 to detect traffic anomalies. These applications and other applications may take collected traffic statistics through traffic monitoring manager 130 and measure traffic flows and make their determinations respectively. Note applications 112-116 are for illustration only, and other applications may utilize data collected through traffic monitoring manager 130 as well. Stating it differently, while applications of detecting attacks and traffic anomalies are illustrated as examples, embodiments of the invention may be applied to a general set of network monitoring applications. The proposed adaptive method provides dynamic zoom-in/zoom-out to the measurement space, and it provides more accurate results with fewer overheads due to the monitoring.

In this architecture, the network elements 140 collects traffic statistics to the network controller 120 periodically. In the collection of the traffic statistics by the network elements, the granularity choices at both the temporal and spatial domains are critical.

In the temporal domain, if the statistics are collected in a large interval, e.g., half an hour, the applications (e.g., anomaly detection system 116) may not be able to get data in the finer granularity that are required for the application (e.g., identifying traffic spike and other short-lived anomalies). On the other hand, if the collection is done every few seconds, it may generate a lot of traffic to the network, and the large amount of load may overwhelm network controller 120. Thus, it is advantageous to adjust the collection interval dynamically as a part of the zoom-in/out of traffic statistics collection.

In the spatial domain, if the statistics are collected for a single monitor (e.g., a counter) to summarize a large number of traffic flows, the statistics for the large number of traffic flows may mask issues on a few traffic flows within the large traffic flow aggregate. On the other hand, if the collection is done for small number of traffic flows or each of the traffic flows, the finer granularity also generates a lot of traffic to the network and may overwhelm network controller 120 too. Thus, it is advantageous to adjust the number of traffic flows monitored for collection dynamically as a part of the zoom-in/out of traffic statistics collection.

In one embodiment, in order to achieve efficiency in the spatial domain, the collection of traffic statistics are implemented monitoring both the large number of traffic flows and a set of traffic flows within the large number of traffic flows. FIG. 1B illustrates monitoring traffic flows according to one embodiment of the invention. The traffic flows are bundled together as traffic aggregates. For example, flows 1-10 at references 152-156 form a traffic aggregate, which becomes a first set of traffic flows to monitor at reference 162. The bundling of traffic flows may be based on characteristics of the traffic flows, e.g., the shared full/partial source or destination addresses. The traffic aggregate is monitored by monitor 1 at reference 172.

From the traffic aggregate, one or more traffic flows are selected for monitoring at reference 192. The selection may be random, e.g., based on a predetermined probability to select the one or more traffic flows from the traffic aggregate. In this example, traffic flow 2 is selected to be monitored. Traffic flow 2 becomes a second set of traffic flows to monitor at reference 164, and it is monitored by monitor 2 at reference 174. The two sets of traffic flows are shown to be monitored by the same network element 170, but it does not need to be and for a different traffic aggregates, the traffic aggregate and its flow(s) may be monitored by separate network elements. Thus, the sets of traffic flows to be monitored by monitors may be one of traffic aggregates or one or more traffic flows selected from traffic aggregates.

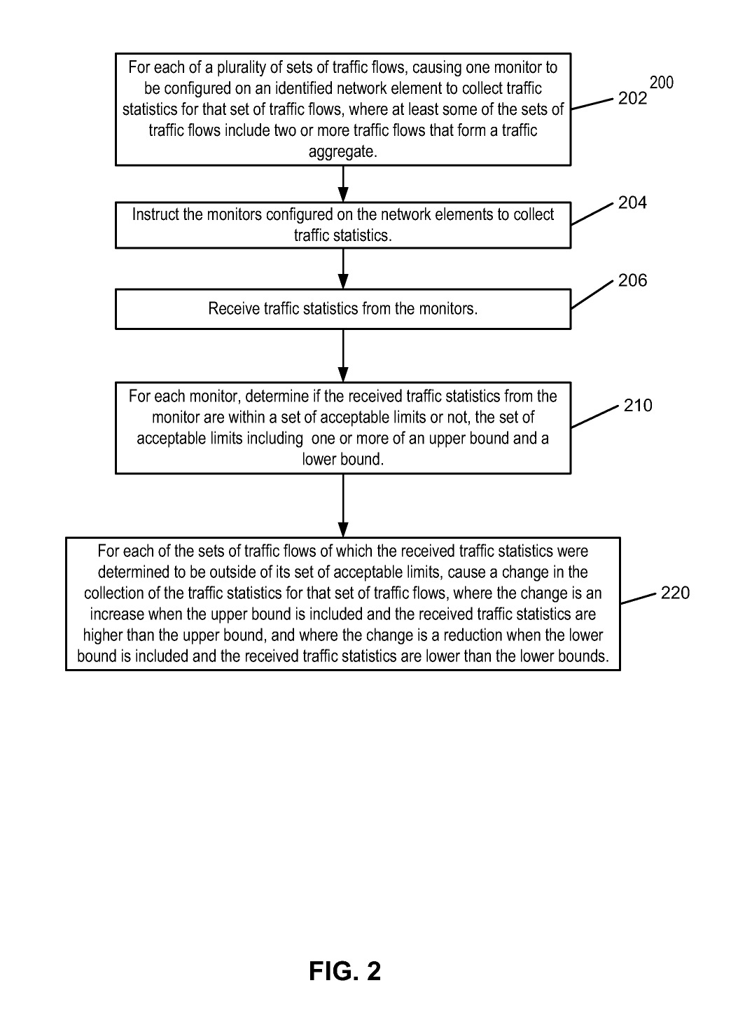

FIG. 2 is a flow diagram illustrating a method for dynamically collect traffic statistics in a SDN system according to one embodiment of the invention. Method 200 may be implemented in traffic monitoring manager 130 within network controller 120 as illustrated in FIG. 1, where traffic flows are transmitted through the network by the network elements (e.g. forwarding elements, OpenFlow switches).

At reference 202, for each of a plurality of sets of traffic flows, the traffic monitoring manager causes a monitor to be configured on an identified network element to collect traffic statistics. At least some of the sets of traffic flows include two or more traffic flows that form a traffic aggregate. The placement of monitors is discussed in more details herein below.

At reference 204, the traffic monitoring manager instructs the monitors configured on the network elements to collect traffic statistics. Traffic statistics may include various parameters of the sets of traffic flows. For example, the parameters may include packet counts for total packets, dropped packets, and error packets in a given period. The monitors collect traffic statistics based on a predetermined rules (e.g., wildcard rules specifically for traffic statistics collection that may be different from the forwarding rules) on the network elements. At reference 206, the traffic monitoring manager receives the traffic statistics from the monitors.

At reference 210, the traffic monitoring manager determines if the received traffic statistics from the monitor are within a set of acceptable limits or not. The set of acceptable limits includes one or more of an upper bound and a lower bound. The determination is discussed in more details herein below.

Then at reference 212, for each of the sets of traffic flows of which the received traffic statistics were determined to be outside of its set of acceptable limits, the traffic monitoring manager causes a change in the collection of the traffic statistics for that set of traffic flows, where the change is an increase when the upper bound is included and the received traffic statistics are higher than the upper bound, and where the change is a reduction when the lower bound is included and the received traffic statistics are lower than the lower bound. The causing may be performed through the traffic monitoring manager issues a message to the associated network element in one embodiment.

Method 200 starts with collecting coarse-grained statistics on larger traffic aggregates (e.g., traffic flows grouped together based on address blocks), and it compares with the set of acceptable limits. The set of acceptable limits is formed based on historical data of the traffic aggregates. Once suspicious deviation is identified through the comparison, the traffic monitoring manager adjust the collection of the traffic statistics and produce a finer-grained collection. The adjustment may run several iterations. In that case the traffic monitoring manager may cause the change in reference 212 and the method returns to reference 204 and the updated traffic statistics are analyzed again to see whether even finer-grained collection is needed. The iterations produce the desired granularity for traffic monitor and the granularity may be adjusted dynamically based on collected traffic statistics.

Monitor Placement

As discussed herein above, configuring monitors to network elements of a SDN system is an important initial process. In a traditional data network, each router typically independently monitor packets or traffic flows with some sampling probability. Each router conducting measurement independently of each other leads to redundant flow measurements and inefficient use of router resources. In a SDN system, with the network controller having a centralized view of the network, the redundancy and inefficiency can be removed.

For monitoring traffic statistics in a SDN system, a simple way is to let each ingress network element collect traffic statistics for all the flows coming into the network. Yet, that may overload the ingress network elements. Thus it is desirable to distribute traffic monitoring functionalities and monitors among multiple network elements that the traffic flows are transmitted by. Since the network controller has knowledge of the complete network topology and routing path for each traffic flow, the network controller may compute an optimal way to configure monitors to the network elements of the SDN system.

The problem may be described mathematically. Given a network G=<V, E>, where V is the set of network elements and E is the set of edges. The set of traffic flows to be monitored is F, the problem is to find the best mapping F→V. The mapping should satisfy certain constraints of the network elements. For example, the number of monitors for a network element v within V should not exceed the number of monitors that v may accommodate. Similarly, the bandwidth used to send traffic statistics to the network controller should not exceed the capacity of the network element. The set of constraints of each network element, including the number of monitors and the bandwidth capacity limits, may be denoted as N, and it is one of the inputs to the placement algorithm.

Even after spreading the monitoring load across the network, it is still desirable to have spatial aggregation to further reduce the monitoring load. For example, instead of having a monitor for each traffic flow, one may have a monitor for a traffic aggregate of traffic flows sharing a /24 prefix in its IP address. Yet, large traffic aggregate may mask anomalies that are only visible to a subset of flows, thus, as discussed herein above in relating to FIG. 1B, one may monitor the larger traffic aggregates (e.g., the first set of traffic flows 162) and sample a few smaller aggregates (e.g., the second set of traffic flows 164) simultaneously.

In one embodiment, a header space divider D is to be applied to the entire header space of traffic flows. For example, the aggregate can be based on destination address blocks or source address blocks. It can also be based on different port numbers, reflecting different applications. An operator may define and change the divider flexibly. To overcome the problem of larger aggregates covering changes in smaller groups within this aggregate, we also perform random sampling of smaller groups with the rate r. The smaller r is, the fewer loads it introduces.

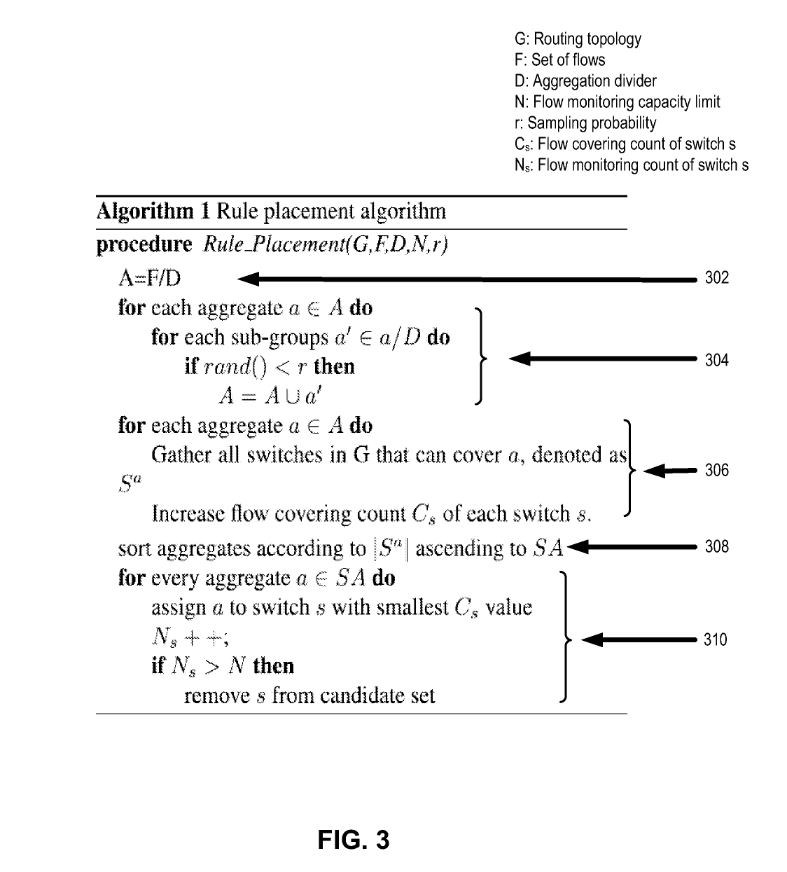

FIG. 3 is a pseudo code program illustrating an algorithm for placing monitors to network elements according one embodiment of the invention. The input of the algorithm includes: routing topology G, set of flows F, aggregation divider D, and sampling probability r. Note that in this embodiment, the network elements are switches and the monitors are counters containing rules for counting traffic flows.

At reference 302, aggregate sets is set to be A (the monitor set), which is generated by applying D on F. Then at reference 304, for each aggregate a within aggregate set A, a subgroup of traffic flow within aggregate a, denoted as a′, is selected, through a random sampling rand( ) at a sampling rate r. Thus, the aggregate set A now include both the first set of traffic flows and the second set of traffic flows as illustrated in FIG. 1B.

At reference 306, using topology G, for each of the monitor set A, a set of switches are marked in set S^{a} as the set that may be able to monitor the element. The flow covering counts Cₛ are calculated for each switch s.

Then the aggregates are sorted according to the flow covering counts Cₛ at reference 308, where each SDN switch counted is one that the aggregate passes through. At reference 310, for each aggregate, a switch is assigned, starting with the switch with lowest flow covering counts Cₛ. Once the switch is assigned, a monitor assignment count, Nₛ is increased by one. The switch is removed from candidate set once Nₛ reaches the monitoring count limitation, N. The process completes once all aggregates within A are assigned.

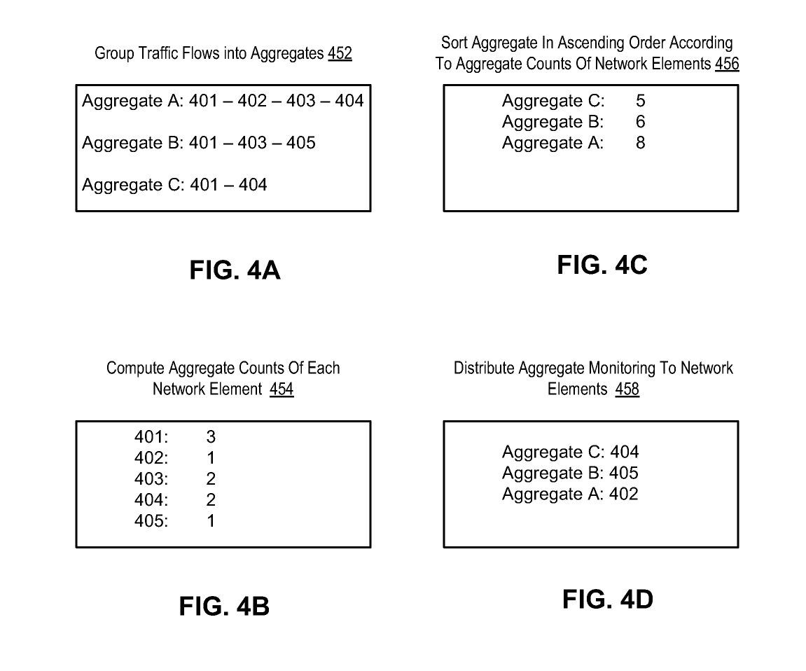

FIGS. 4A-D illustrates an example of monitor placement according to one embodiment of the invention. In FIG. 4A, traffic flows are grouped into various traffic aggregates. Each traffic aggregate contains a number of traffic flows that share some common characteristics. For example, all traffic flows within an aggregate share a common route within the network. Thus each traffic aggregate is associated with a set of network elements by which traffic flows are transmitted.

In FIG. 4B, each network element is given an aggregate count based on how many traffic aggregates the network element transmits through. The aggregate counts are used to denote the number of traffic aggregates a network element may cover, as a network device can only cover a traffic aggregate that is transmitted by the network device. In this example, network element 401 has the highest count at 3 as all three aggregates being forwarded through it (thus network element 401 is an ingress) while network elements 402 and 405 have the lowest count at 1 as only aggregates A and B being forwarded through them respectively.

In FIG. 4C, the aggregates are sorted based on aggregate counts in an ascending order, where the aggregate with the lowest aggregate count is listed first and the aggregate with the highest aggregate count being listed last. Thus aggregate C is the first in the sorted list and aggregate A is the last.

Then in FIG. 4D, the method assigns each aggregate with the network element with the lowest aggregate count. In this example, since aggregate C can be monitored by both network elements 401 and 404, and 404 has lower aggregate count, aggregate C is assigned to be monitored by network element 404. Aggregate B may be monitored by 401, 403, or 405. Since 405 has the lowest aggregate count, aggregate B is assigned to be monitored by network element 405. Similarly, aggregate A is assigned to be monitored by network element 402.

In an operating network, generally there are a lot more traffic aggregates, and a network element often needs to monitor multiple traffic aggregates. A network element has a capacity limit as of how many traffic aggregate it can monitor. In one embodiment, a network element is not removed from the candidate network element set until the network element has been assigned to a number of traffic aggregates, where the number reaches its capacity limit.

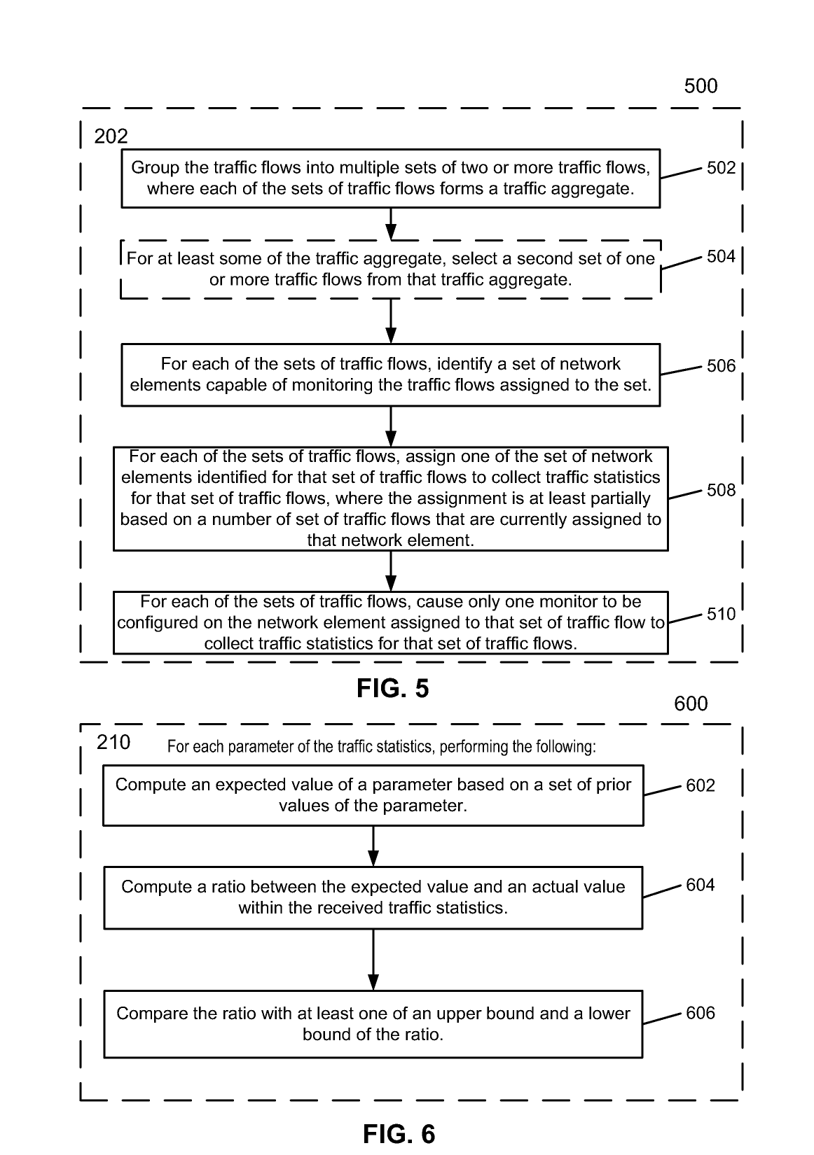

FIG. 5 is a flow diagram illustrating a method of monitor placement according to one embodiment of the invention. Method 500 can be implemented in network controller 120, more specifically traffic monitoring manager 130, of FIG. 1A. Method 500 may be an embodiment of operations within reference 202 of FIG. 2.

Method 500 starts with grouping traffic flows of a network into multiple sets of two or more traffic flows, where each of the sets of traffic flows forms a traffic aggregate at reference 502. Each aggregate is to be monitored separately for traffic anomalies. Traffic flows can be grouped based on a variety of criteria. For example, the grouping can be based on source or destination address blocks of traffic flows, port numbers reflecting different applications, or other traffic characteristics. An operator of a network may change the traffic grouping based on network condition and the network of anomaly detection.

Note method 500 may be triggered by a traffic flow update within the network. For example, when a traffic flow is created or removed from the network. It may also triggered by a request by a network operator, where the network manager indicates a list of traffic flows to be grouped and optionally how the list of traffic flows to be grouped (e.g., what traffic characteristics to be utilized in making the grouping).

Optionally the method proceeds to reference 504, where for at least some of the traffic aggregates, the network controller selects a second set of one or more traffic flows form that traffic aggregate. The operation is use to zoom in the traffic aggregate and collect traffic statistics in smaller groups otherwise masked by a larger aggregate. The subgroup of traffic flows within the traffic aggregate is selected by randomly sampling the aggregate with a predetermined probability in one embodiment. The larger the sampling probability, the more subgroups are added to the set of traffic flows to be monitored. Thus, with the operations of reference 404, the set of traffic flows to be monitored includes both traffic aggregates and subgroups of traffic flows within the set of traffic aggregates.

The method proceeds to reference 506, where the network controller identifies a set of network elements capable of monitoring the traffic flows assigned to the set. A network element is capable of monitor the traffic flows that are transmitted by the network element, thus the network controller needs to identifies the set of network elements for each set of traffic flows.

The method proceeds to reference 508, where for each of the sets of traffic flows, the network controller assigns one of the set of network elements identified for that set of traffic flows to collect traffic statistics for that set of traffic flows. The assignment is at least partially based on a number of set of traffic flows that are currently assigned to that network element. The assignment may be also based the capacity limit of a number of monitors that network element may be able to accommodate.

The method then proceeds to reference 510, where for each of the sets of traffic flows, the network controller causes only one monitor to be configured on the network element assigned to that set of traffic flows to collect traffic statistics for that set of traffic flows.

One embodiment of method 500 is illustrated in FIG. 3, but other embodiments with different means to sort traffic aggregates and select network elements can be implemented following the principle disclosed.

Determination of Received Traffic Statistics within Limits or not

Once the monitoring function is distributed among multiple network elements, the assigned monitors configured to the network elements will then collect traffic statistics for the sets of traffic flows assigned. The collected traffic statistics are sent to the network controller. The network controller receives the traffic statistics from the monitors and determine if the traffic statistics are within acceptable limits.

FIG. 6 is a flow diagram illustrating determination of whether or not the received traffic statistics are within the acceptable limits according to one embodiment of the invention. Method 600 can be implemented in network controller 120, more specifically traffic monitoring manager 130, of FIG. 1A. Method 600 may be an embodiment of operations within reference 210 of FIG. 2. Method 600 is performed for each parameter of the traffic statistics when the traffic statistics contains more than one parameter.

Method 600 starts with reference 602, where the network controller computes an expected value of a parameter based on a set of prior values of the parameter. In one embodiment, the expected value of the parameter may be computed using liner prediction method.

The linear prediction method uses previous samples to estimate or predict a future measurement. It attempts to predict the value of the next sample. If the value falls into the range of the prediction, it indicates the possibility of contraction. Otherwise, the deviation between the predicted and observed values indicates a change in the network behavior and requires an expansion and more frequent counting to determine the new pattern. To utilize the linear prediction method, the network controller maintains a list of n records for each set of traffic flows. The predicted value of an aggregate a in time tₙ is computed through the following equation:

$${v}_{p}^{a} = {v}_{n}^{a} + \frac{( {t}_{n}^{a} - {t}_{n - 1}^{a} )}{n - 1} {\sum }_{i = 1}^{n - 1} \frac{{v}_{i + 1}^{a} - {v}_{i}^{a}}{{t}_{i + 1}^{a} - {t}_{i}^{a}} \qquad ( 1 )$$

In the equation, n is the number of prior values of the parameter, t is the time associated with a particular value, and v^{a}ₙ is the immediate recent value of the parameter.

At reference 604, the network controller compute a ratio between the expected value and an actual value within the received traffic statistics. In one embodiment, the ratio may be computed using the following equation:

$$R ( {v}_{p}^{a} ) = \vert \frac{{v}_{p}^{a} - {v}_{n}^{a}}{{v}_{n + 1}^{a} - {v}_{n}^{a}} \vert \qquad ( 2 )$$

Then at reference 606, the computed ratio is compared with at least one of an upper bound and a lower bound of the ratio. The lower bound and the upper bound may be computed with the following equations:

R^{a}_{L}=R(meanₐ−3×stdₐ) (3)

R^{a}_{U}=R(meanₐ+3×stdₐ) (4)

The meanₐ and stdₐ are the average and standard deviation of the set of traffic flows a computed using the exponentially weighted moving average (EWMA). If R(vₚ^{a}) is below R_{U}, the measured parameter is changing faster than the prediction. Such behavior indicates more activity than predicted, so that the monitoring granularity should be finer to yield more accurate data values on which to base future predictions on. Conversely, if R(vₚ^{a}) is above R_{U}, the measured value is changing more slowly than the prediction, so that the monitoring granularity should be coarser to yield less data. Note the ratio is below the lower bound indicates that the received parameter value is over an upper bound for the parameter as the ratio has the actual value at the bottom of equation (2) while the predicted value at the top of the equation. Similarly, the ratio is above the upper bound indicates that the received parameter value is lower than a lower bound of the parameter.

In one embodiment, the comparison of the ratio with at least one of the lower bound and upper bound yields a flag to the set of traffic flows. The flag is marked as EXPAND to indicate that the monitored set of traffic flows needs to be monitored more when one of the parameters of the traffic statistics is over the upper bound, while the flag being marked as CONTRACT indicates that the monitored set of traffic flows need to be monitored less when one of the parameters of the traffic statistics is below the lower bound. The flag may be marked when several or all of the parameters is outside of the set of limits formed by the upper bounds and lower bounds in one embodiment.

Dynamic Zoom-in and Zoom-Out of Collection of Traffic Statistics

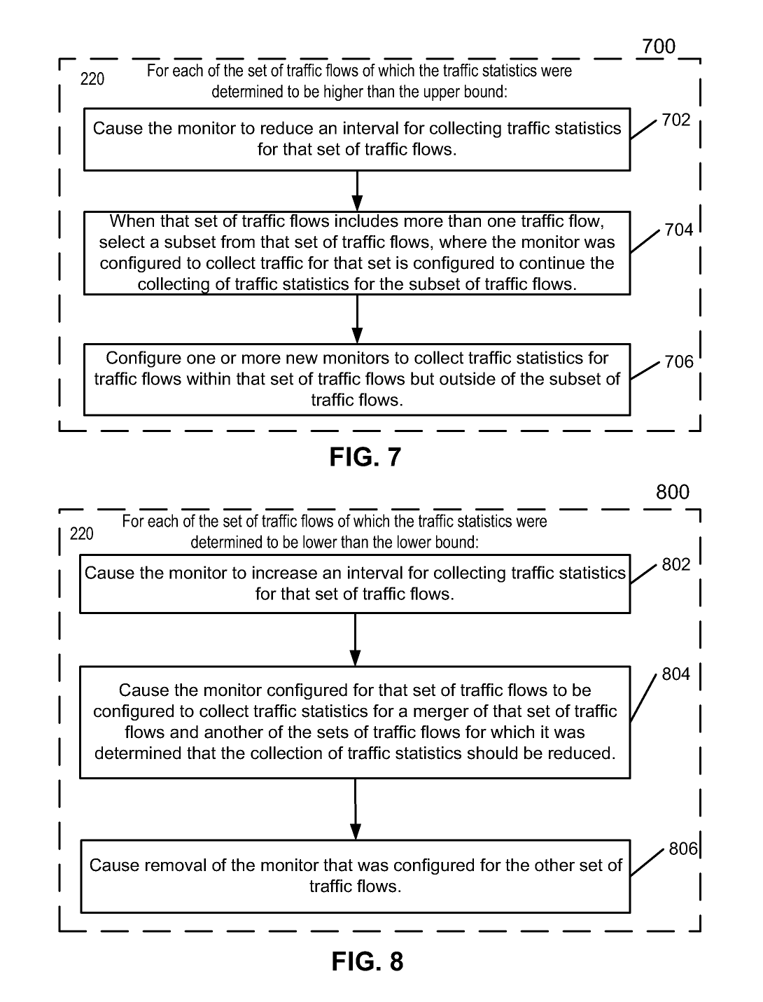

Once it is determined that the received traffic statistics from the monitors are within the set of acceptable limits, the network controller then performs dynamic zoom-in and zoom-out for the set of traffic flows that the received traffic statistics are outside of the set of acceptable limits. FIG. 7 is a flow diagram illustrating a method of zoom-in of collection of traffic statistics according to one embodiment of the invention. Method 700 can be implemented in network controller 120, more specifically traffic monitoring manager 130, of FIG. 1A. Method 700 may be an embodiment of operations within reference 220 of FIG. 2. Method 700 is performed for each of the set of traffic flows of which the traffic statistics were determined to be higher than the upper bound.

At reference 702, the network controller causes the monitor associated with the set of traffic flow to reduce an interval for collecting traffic statistics for that set of traffic flows. In one embodiment, the interval for collecting traffic statistics is reduced by half. In one embodiment, the interval for collecting the traffic statistics and reporting the traffic statistics are the same, thus the change of the interval for collecting traffic statistics also changes the interval for reporting the traffic statistics. In an alternate embodiment, the interval for collecting the traffic statistics and reporting the traffic statistics are different (e.g., when Kalman filter is utilized), and the change of the interval for collecting traffic statistics may not change the interval for reporting the traffic statistics, or it may cause the interval for reporting the traffic statistics change differently.

At reference 704, when that set of traffic flows includes more than one traffic flow, the network controller selects a subset from that set of traffic flows, where that monitor that was configured to collect traffic statistics for that set of traffic flows is configured to continue the collecting of traffic statistics for the subset of traffic flows. In one embodiment, the network controller select substantially half of the traffic flows within the set to continue the collection.

At reference 706, the network controller configures one or more new monitors to collect traffic statistics for traffic flows within that set of traffic flows but outside of the subset of the traffic flows. With new monitors are configured, the set of traffic flows are split into two or more sets of traffic flows, each new set of traffic flows is monitored by one new monitor. The network controller may configure the new monitors according to method 500 discussed herein above.

Note that operations in reference 702 may be performed without operations in references 704-706 as the operations in reference 702 may provide further temporal granularity without enhancing spatial granularity provided by operations in references 704-706; vice versa, operations in reference 704-706 may be performed without operations in reference 702.

FIG. 8 is a flow diagram illustrating a method of zoom-out of collection of traffic statistics according to one embodiment of the invention. Method 800 can be implemented in network controller 120, more specifically traffic monitoring manager 130, of FIG. 1A. Method 800 may be an embodiment of operations within reference 220 of FIG. 2. Method 800 is performed for each of the set of traffic flows of which the traffic statistics were determined to be lower than the lower bound.

At reference 802, the network controller causes the monitor associated with the set of traffic flow to increase an interval for collecting traffic statistics for that set of traffic flows. In one embodiment, the interval for collecting traffic statistics is doubled.

At reference 804, the network controller causes the monitor configured for that set of traffic flows to be configured to collect traffic statistics for a merger of that set of traffic flows and another of the sets of traffic flows for which it was determined that the collection of traffic statistics should be reduced. The other of the sets of traffic flows may be a set of traffic flows that is close to that set of traffic flows logically (e.g., sharing substantial routes in transmission). The determination that the collection of traffic statistics of the other set of traffic flows should be reduced may be marked by CONTRACT as discussed herein above.

At reference 806, the network controller causes removal of the monitor that was configured for the other set of traffic flows. With the merger of the two sets of traffic flows into one set of traffic flows, there is no need of two monitors, thus one of the monitor is removed and the remaining monitor will collect traffic statistics of the merger of the two sets of traffic flows.

Note that operations in reference 802 may be performed without operations in references 804-806 as the operations in reference 802 may reduce temporal granularity without reducing spatial granularity provided by operations in references 804-806; vice versa, operations in reference 804-806 may be performed without operations in reference 802.

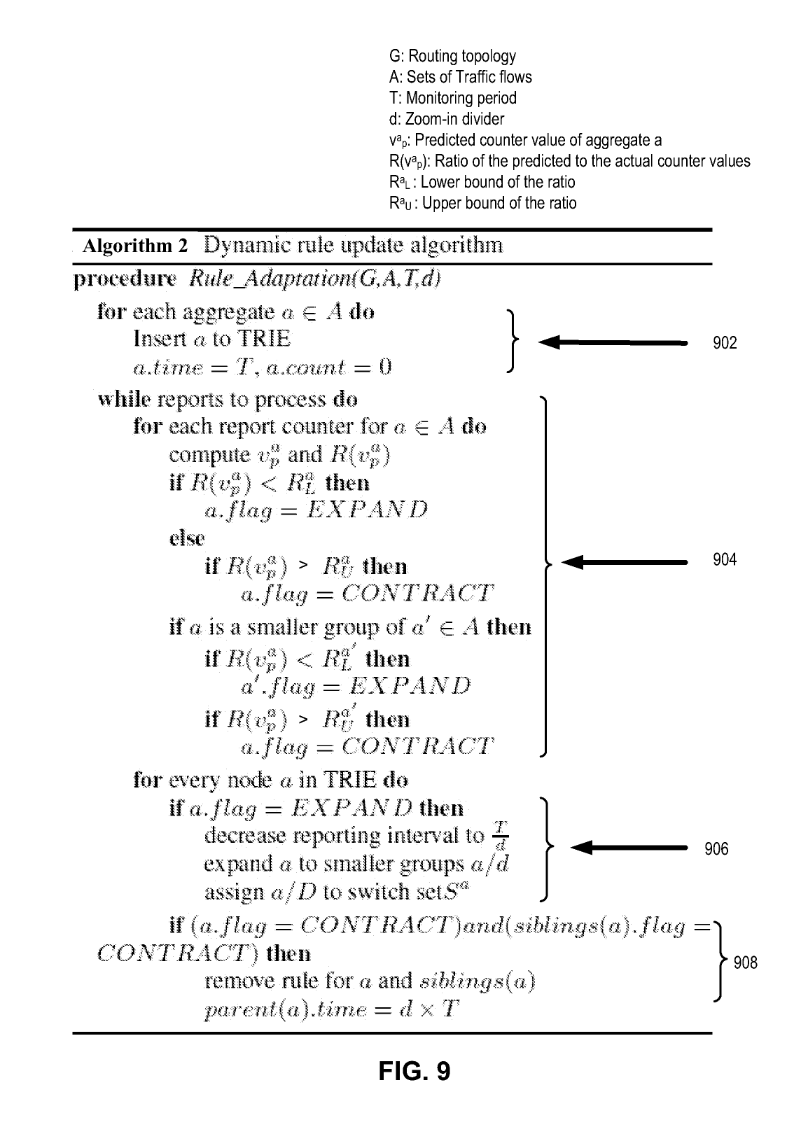

FIG. 9 is a pseudo code program illustrating an algorithm for dynamically collecting statistics of traffic flows according one embodiment of the invention. The pseudo code program may be performed by a network controller such as network controller 120, more specifically traffic monitoring manager 130, of FIG. 1A.

The algorithm takes input of routing topology G of the network, sets of traffic flows A (such as aggregate and one or more traffic flows within an aggregate), monitoring period T, and zoom-in divider d.

At reference 902, the monitor period is set to T. The count, which represents a parameter of traffic statistics is set to zero initially. At reference 904, the network controller receives traffic statistics in the report counters. For each report counter, the ratio between predicated value of the sets of traffic flow (aggregate a in the example) and the received counter value (v^{a}ₚ) is compared to a lower bound of the ratio, which represents an upper bound of the received counter value. If the ratio is lower than the lower bound of the ratio, a flag is set to EXPAND for the aggregate a to increase the collection of the counter values. If the ratio is above an upper bound of the ratio, which represents a lower bound of the received counter value, a flag is set to CONTRACT for the aggregate a to reduce the collection of the counter value. If a is a smaller group of a′, and if the ratio of the smaller group is below the lower bound of the larger group a′, a flag is set to EXPAND for the larger group a′ to increase the collection of the counter values; if the ratio of the smaller group is above the upper bound of the larger group a′, a flag is set to CONTRACT for the larger group a′ to reduce the collection of the counter value.

Then at reference 906, if aggregate a is marked with flag of EXPAND, the reporting interval of the counter is reduced to T/d. The aggregate a is divided up to smaller groups through division of a/d. The smaller groups are assigned to switch set S^{a} for allocating counters.

At reference 908, if aggregate a is marked with flag of CONTRACT, the network controller finds another sibling aggregate of aggregate a that is also marked with flag of CONTRACT, and a rule (which corresponds to a counter) is removed, and the data collection interval is increased to d×T.

Kalman Filter Used in Network Element for Traffic Statistics Collection

Network elements reports the value of traffic statistics periodically to the network controller. The time window T cannot be very small, because too small T may cause huge number of messages to the network controller. Meanwhile, the linear prediction method discussed above requires a list of n records for each aggregate. The memory on the network element are limited, and it not be easy to use linear prediction on the network elements.

The Kalman filter, also known as linear quadratic estimation (LQE), may be useful for traffic statistics collection. The original purpose of Karman filter is to eliminate the random observational error of observation values of a variable. The true value of the variable is considered “static” and does not change rapidly.

To utilize the Kalman filter, for each set of traffic flows, a network element assigns a Kalman filter. The monitor time window T0 can be very small. Instead of reporting the raw values in a more frequent time scale, the network element reports the Kalman filter state variables of an aggregate to the network controller every time window T, or once it detects deviation of traffic statistics. T>T0.

On the network controller, once the network controller receives a set of state Kalman filter state variables of an aggregate, it determines whether to expand or contract the data collection.

With Kalman filter, the network elements collect traffic statistics more often than the frequency of sending to the network controller. The set of traffic statistics include Kalman filter state variables, thus it contains more data than what the network elements would send without the Kalman filter. The main advantage of Kalman filter based traffic statistics collection is that the time interval of traffic statistics collection can be greatly reduced, and at the same time, the number of control messages between the network elements and the network elements is reduced.

SDN and NFV Environment Utilizing Embodiments of the Invention

Embodiments of the invention may be utilized in a SDN and NFV network containing network devices. A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 10A illustrates connectivity between network devices (NDs) within an exemplary network, as well as three exemplary implementations of the NDs, according to some embodiments of the invention. FIG. 10A shows NDs 1000A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 1000A, E, and F illustrates that these NDs act as ingress and egress points for the network (and thus, these NDs are sometimes referred to as edge NDs; while the other NDs may be called core NDs).

Two of the exemplary ND implementations in FIG. 10A are: 1) a special-purpose network device 1002 that uses custom application—specific integrated—circuits (ASICs) and a proprietary operating system (OS); and 2) a general purpose network device 1004 that uses common off-the-shelf (COTS) processors and a standard OS.

The special-purpose network device 1002 includes networking hardware 1010 comprising compute resource(s) 1012 (which typically include a set of one or more processors), forwarding resource(s) 1014 (which typically include one or more ASICs and/or network processors), and physical network interfaces (NIs) 1016 (sometimes called physical ports), as well as non-transitory machine readable storage media 1018 having stored therein networking software, such as monitor 1020, which is a software module configured on special purpose network device 1002 for collecting traffic statistics. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1000A-H. During operation, the monitor 1020 may be executed by the networking hardware 1010 to instantiate a set of one or more monitor instance(s) (MIs) 1021. Each of the monitor instance(s) 1021, and that part of the networking hardware 1010 that executes that monitor instance (be it hardware dedicated to that networking software instance and/or time slices of hardware temporally shared by that networking software instance with others of the monitor instance(s) 1022), form a separate virtual network element 1030A-R. Each of the virtual network element(s) (VNEs) 1030A-R includes a control communication and configuration module 1032A-R (sometimes referred to as a local control module or control communication module) and forwarding table(s) 1034A-R, such that a given virtual network element (e.g., 1030A) includes the control communication and configuration module (e.g., 1032A), a set of one or more forwarding table(s) (e.g., 1034A), and that portion of the networking hardware 1010 that executes the virtual network element (e.g., 1030A).

The special-purpose network device 1002 is often physically and/or logically considered to include: 1) a ND control plane 1024 (sometimes referred to as a control plane) comprising the compute resource(s) 1012 that execute the control communication and configuration module(s) 1032A-R; and 2) a ND forwarding plane 1026 (sometimes referred to as a forwarding plane, a data plane, or a media plane) comprising the forwarding resource(s) 1014 that utilize the forwarding table(s) 1034A-R and the physical NIs 1016. By way of example, where the ND is a router (or is implementing routing functionality), the ND control plane 1024 (the compute resource(s) 1012 executing the control communication and configuration module(s) 1032A-R) is typically responsible for participating in controlling how data (e.g., packets) is to be routed (e.g., the next hop for the data and the outgoing physical NI for that data) and storing that routing information in the forwarding table(s) 1034A-R, and the ND forwarding plane 1026 is responsible for receiving that data on the physical NIs 1016 and forwarding that data out the appropriate ones of the physical NIs 1016 based on the forwarding table(s) 1034A-R.

FIG. 10B illustrates an exemplary way to implement the special-purpose network device 1002 according to some embodiments of the invention. FIG. 10B shows a special-purpose network device including cards 1038 (typically hot pluggable). While in some embodiments the cards 1038 are of two types (one or more that operate as the ND forwarding plane 1026 (sometimes called line cards), and one or more that operate to implement the ND control plane 1024 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1036 (e.g., a first full mesh coupling the line cards and a second full mesh coupling all of the cards).

Returning to FIG. 10A, the general purpose network device 1004 includes hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein monitor 1050. During operation, the processor(s) 1042 execute the monitor 1050 to instantiate a hypervisor 1054 (sometimes referred to as a virtual machine monitor (VMM)) and one or more virtual machines 1062A-R that are run by the hypervisor 1054, which are collectively referred to as software instance(s) 1052. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1062A-R, and that part of the hardware 1040 that executes that virtual machine (be it hardware dedicated to that virtual machine and/or time slices of hardware temporally shared by that virtual machine with others of the virtual machine(s) 1062A-R), forms a separate virtual network element(s) 1060A-R.

The virtual network element(s) 1060A-R perform similar functionality to the virtual network element(s) 1030A-R. The monitor instances 1066 and 1068 are instantiated in virtual machines 1062A to 1062R. The hypervisor 1054 may present a virtual operating platform that appears like networking hardware 1010 to virtual machine 1062A, and the virtual machine 1062A may be used to implement functionality similar to the control communication and configuration module(s) 1032A and forwarding table(s) 1034A (this virtualization of the hardware 1040 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 1062A-R differently. For example, while embodiments of the invention are illustrated with each virtual machine 1062A-R corresponding to one VNE 1060A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 1054 includes a virtual switch that provides similar forwarding services as a physical Ethernet switch. Specifically, this virtual switch forwards traffic between virtual machines and the NIC(s) 1044, as well as optionally between the virtual machines 1062A-R; in addition, this virtual switch may enforce network isolation between the VNEs 1060A-R that by policy are not permitted to communicate with each other (e.g., by honoring virtual local area networks (VLANs)).

The third exemplary ND implementation in FIG. 10A is a hybrid network device 1006, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 1002) could provide for para-virtualization to the networking hardware present in the hybrid network device 1006.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1030A-R, VNEs 1060A-R, and those in the hybrid network device 1006) receives data on the physical NIs (e.g., 1016, 1046) and forwards that data out the appropriate ones of the physical NIs (e.g., 1016, 1046). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 10C illustrates various exemplary ways in which VNEs may be coupled according to some embodiments of the invention. FIG. 10C shows VNEs 1070A.1-1070A.P (and optionally VNEs 1070A.Q-1070A.R) implemented in ND 1000A and VNE 1070H.1 in ND 1000H. In FIG. 10C, VNEs 1070A.1-P are separate from each other in the sense that they can receive packets from outside ND 1000A and forward packets outside of ND 1000A; VNE 1070A.1 is coupled with VNE 1070H.1, and thus they communicate packets between their respective NDs; VNE 1070A.2-1070A.3 may optionally forward packets between themselves without forwarding them outside of the ND 1000A; and VNE 1070A.P may optionally be the first in a chain of VNEs that includes VNE 1070A.Q followed by VNE 1070A.R (this is sometimes referred to as dynamic service chaining, where each of the VNEs in the series of VNEs provides a different service—e.g., one or more layer 4-7 network services). While FIG. 10C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 10A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 10A may also host one or more such servers (e.g., in the case of the general purpose network device 1004, one or more of the virtual machines 1062A-R may operate as servers; the same would be true for the hybrid network device 1006; in the case of the special-purpose network device 1002, one or more such servers could also be run on a hypervisor executed by the compute resource(s) 1012); in which case the servers are said to be co-located with the VNEs of that ND.

A virtual network is a logical abstraction of a physical network (such as that in FIG. 10A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 10D illustrates a network with a single network element on each of the NDs of FIG. 10A. Specifically, FIG. 10D illustrates network elements (NEs) 1070A-H with the same connectivity as the NDs 1000A-H of FIG. 10A with a centralized approach for maintaining reachability and forwarding information (also called network control), according to some embodiments of the invention.

FIG. 10D illustrates that a centralized approach 1074 (also known as software defined networking (SDN)) that decouples the system that makes decisions about where traffic is sent from the underlying systems that forwards traffic to the selected destination. The illustrated centralized approach 1074 has the responsibility for the generation of reachability and forwarding information in a centralized control plane 1076 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 1076 has a south bound interface 1082 with a data plane 1080 (sometime referred to the infrastructure layer, network forwarding plane, or forwarding plane (which should not be confused with a ND forwarding plane)) that includes the NEs 1070A-H (sometimes referred to as switches, forwarding elements, data plane elements, or nodes). The centralized control plane 1076 includes a network controller 1078, which includes a centralized reachability and forwarding information module 1079 that determines the reachability within the network and distributes the forwarding information to the NEs 1070A-H of the data plane 1080 over the south bound interface 1082 (which may use the OpenFlow protocol). The centralized reachability and forwarding information module 1079 contains traffic monitoring manager 130 as illustrated in FIG. 1A.

The network intelligence is centralized in the centralized control plane 1076 executing on electronic devices that are typically separate from the NDs. For example, where the special-purpose network device 1002 is used in the data plane 1080, each of the control communication and configuration module(s) 1032A-R of the ND control plane 1024 typically include a control agent that provides the VNE side of the south bound interface 1082. In this case, the ND control plane 1024 (the compute resource(s) 1012 executing the control communication and configuration module(s) 1032A-R) performs its responsibility for participating in controlling how data (e.g., packets) is to be routed (e.g., the next hop for the data and the outgoing physical NI for that data) through the control agent communicating with the centralized control plane 1076 to receive the forwarding information (and in some cases, the reachability information) from the centralized reachability and forwarding information module 1079 (it should be understood that in some embodiments of the invention, the control communication and configuration module(s) 1032A-R, in addition to communicating with the centralized control plane 1076, may also play some role in determining reachability and/or calculating forwarding information—albeit less so than in the case of a distributed approach; such embodiments are generally considered to fall under the centralized approach 1074, but may also be considered a hybrid approach).

While the above example uses the special-purpose network device 1002, the same centralized approach 1074 can be implemented with the general purpose network device 1004 (e.g., each of the VNE 1060A-R performs its responsibility for controlling how data (e.g., packets) is to be routed (e.g., the next hop for the data and the outgoing physical NI for that data) by communicating with the centralized control plane 1076 to receive the forwarding information (and in some cases, the reachability information) from the centralized reachability and forwarding information module 1079; it should be understood that in some embodiments of the invention, the VNEs 1060A-R, in addition to communicating with the centralized control plane 1076, may also play some role in determining reachability and/or calculating forwarding information—albeit less so than in the case of a distributed approach) and the hybrid network device 1006. In fact, the use of SDN techniques can enhance the NFV techniques typically used in the general purpose network device 1004 or hybrid network device 1006 implementations as NFV is able to support SDN by providing an infrastructure upon which the SDN software can be run, and NFV and SDN both aim to make use of commodity server hardware and physical switches.

FIG. 10D also shows that the centralized control plane 1076 has a north bound interface 1084 to an application layer 1086, in which resides application(s) 1088. The centralized control plane 1076 has the ability to form virtual networks 1092 (sometimes referred to as a logical forwarding plane, network services, or overlay networks (with the NEs 1070A-H of the data plane 1080 being the underlay network)) for the application(s) 1088. Thus, the centralized control plane 1076 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 10D illustrates the simple case where each of the NDs 1000A-H implements a single NE 1070A-H, it should be understood that the network control approaches described with reference to FIG. 10D also work for networks where one or more of the NDs 1000A-H implement multiple VNEs (e.g., VNEs 1030A-R, VNEs 1060A-R, those in the hybrid network device 1006). Alternatively or in addition, the network controller 1078 may also emulate the implementation of multiple VNEs in a single ND. Specifically, instead of (or in addition to) implementing multiple VNEs in a single ND, the network controller 1078 may present the implementation of a VNE/NE in a single ND as multiple VNEs in the virtual networks 1092 (all in the same one of the virtual network(s) 1092, each in different ones of the virtual network(s) 1092, or some combination). For example, the network controller 1078 may cause an ND to implement a single VNE (a NE) in the underlay network, and then logically divide up the resources of that NE within the centralized control plane 1076 to present different VNEs in the virtual network(s) 1092 (where these different VNEs in the overlay networks are sharing the resources of the single VNE/NE implementation on the ND in the underlay network).

On the other hand, FIGS. 10E and 10F respectively illustrate exemplary abstractions of NEs and VNEs that the network controller 1078 may present as part of different ones of the virtual networks 1092. FIG. 10E illustrates the simple case of where each of the NDs 1000A-H implements a single NE 1070A-H (see FIG. 10D), but the centralized control plane 1076 has abstracted multiple of the NEs in different NDs (the NEs 1070A-C and G-H) into (to represent) a single NE 10701 in one of the virtual network(s) 1092 of FIG. 10D, according to some embodiments of the invention. FIG. 10E shows that in this virtual network, the NE 1070I is coupled to NE 1070D and 1070F, which are both still coupled to NE 1070E.

FIG. 10F illustrates a case where multiple VNEs (VNE 1070A.1 and VNE 1070H.1) are implemented on different NDs (ND 1000A and ND 1000H) and are coupled to each other, and where the centralized control plane 1076 has abstracted these multiple VNEs such that they appear as a single VNE 1070T within one of the virtual networks 1092 of FIG. 10D, according to some embodiments of the invention. Thus, the abstraction of a NE or VNE can span multiple NDs.

While some embodiments of the invention implement the centralized control plane 1076 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 1076, and thus the network controller 1078 including the centralized reachability and forwarding information module 1079, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 11 illustrates, a general purpose control plane device 1104 including hardware 1140 comprising a set of one or more processor(s) 1142 (which are often COTS processors) and network interface controller(s) 1144 (NICs; also known as network interface cards) (which include physical NIs 1146), as well as non-transitory machine readable storage media 1148 having stored therein centralized control plane (CCP) software 1150. CCP software 1150 contains traffic monitoring manager 130 as illustrated in FIG. 1A.

In embodiments that use compute virtualization, the processor(s) 1142 typically execute software to instantiate a hypervisor 1154 (sometimes referred to as a virtual machine monitor (VMM)) and one or more virtual machines 1162A-R that are run by the hypervisor 1154; which are collectively referred to as software instance(s) 1152. A virtual machine is a software implementation of a physical machine that runs programs as if they were executing on a physical, non-virtualized machine; and applications generally are not aware they are running on a virtual machine as opposed to running on a “bare metal” host electronic device, though some systems provide para-virtualization which allows an operating system or application to be aware of the presence of virtualization for optimization purposes. Again, in embodiments where compute virtualization is used, during operation an instance of the CCP software 1150 (illustrated as CCP instance 1176A) on top of an operating system 1164A are typically executed within the virtual machine 1162A. In embodiments where compute virtualization is not used, the CCP instance 1176A on top of operating system 1164A is executed on the “bare metal” general purpose control plane device 1104.

The operating system 1164A provides basic processing, input/output (I/O), and networking capabilities. In some embodiments, the CCP instance 1176A includes a network controller instance 1178. The network controller instance 1178 includes a centralized reachability and forwarding information module instance 1179 (which is a middleware layer providing the context of the network controller 1078 to the operating system 1164A and communicating with the various NEs), and an CCP application layer 1180 (sometimes referred to as an application layer) over the middleware layer (providing the intelligence required for various network operations such as protocols, network situational awareness, and user—interfaces). At a more abstract level, this CCP application layer 1180 within the centralized control plane 1076 works with virtual network view(s) (logical view(s) of the network) and the middleware layer provides the conversion from the virtual networks to the physical view. CCP application layer 1180 contains traffic monitoring manager instance 1130 which is an instance of traffic monitoring manager 130.

The centralized control plane 1076 transmits relevant messages to the data plane 1080 based on CCP application layer 1180 calculations and middleware layer mapping for each flow. A flow may be defined as a set of packets whose headers match a given pattern of bits; in this sense, traditional IP forwarding is also flow—based forwarding where the flows are defined by the destination IP address for example; however, in other implementations, the given pattern of bits used for a flow definition may include more fields (e.g., 10 or more) in the packet headers. Different NDs/NEs/VNEs of the data plane 1080 may receive different messages, and thus different forwarding information. The data plane 1080 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 1080, the packet (or a subset of the packet header and content) is typically forwarded to the centralized control plane 1076. The centralized control plane 1076 will then program forwarding table entries into the data plane 1080 to accommodate packets belonging to the flow of the unknown packet. Once a specific forwarding table entry has been programmed into the data plane 1080 by the centralized control plane 676, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

The operations of the flow diagrams FIGS. 2 and 5-8 are described with reference to the exemplary embodiment of FIGS. 1A, 10, and 11. However, it should be understood that the operations of flow diagrams can be performed by embodiments of the invention other than those discussed with reference to the exemplary embodiment of FIGS. 1A, 10, and 11, and the exemplary embodiment of FIGS. 1A, 10, and 11 can perform operations different than those discussed with reference to the flow diagrams of FIGS. 2 and 5-8.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

Different embodiments of the invention may be implemented using different combinations of software, firmware, and/or hardware. Thus, the techniques shown in the figures can be implemented using code and data stored and executed on one or more electronic devices (e.g., an end system, a network device). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented in an electronic device serving as a software-defined network (SDN) controller in a network containing network elements, wherein traffic flows are transmitted through the network by the network elements, the method comprising:
for each of a plurality of sets of traffic flows, causing a monitor to be configured on an identified network element to collect traffic statistics for that set of traffic flows, wherein at least some of the sets of traffic flows include two or more traffic flows that form a traffic aggregate;
instructing the monitors configured on the network elements to collect traffic statistics;
receiving the traffic statistics from the monitors;
for each monitor, determining if the received traffic statistics from the monitor are within a set of acceptable limits or not, wherein the set of acceptable limits includes one or more of an upper bound and a lower bound; and
for each of the sets of traffic flows of which the received traffic statistics were determined to be outside of its set of acceptable limits, causing a change in the collection of the traffic statistics for that set of traffic flows, wherein the change is an increase when the upper bound is included and the received traffic statistics are higher than the upper bound, and wherein the change is a reduction when the lower bound is included and the received traffic statistics are lower than the lower bound.

2. The method of claim 1, wherein the causing, for each of the plurality of sets of traffic flows, the monitor to be configured comprises:
grouping the traffic flows into multiple sets of two or more traffic flows, wherein each of the sets of traffic flows forms a traffic aggregate;
for each of the sets of traffic flows, identifying a set of one or more network elements capable of monitoring the traffic flows assigned to the set;
for each of the sets of traffic flows, assigning one of the set of network elements identified for that set of traffic flows to collect traffic statistics for that set of traffic flows, wherein the assignment is at least partially based on a number of the sets of traffic flows that are currently assigned to that network element; and
for each of the sets of traffic flows, causing only one monitor to be configured on the network element assigned to that set of traffic flows to collect traffic statistics for that set of traffic flows.

3. The method of claim 2, further comprising:
for at least some of the traffic aggregates, selecting a set of one or more of the traffic flows from that traffic aggregate based on a predetermined probability.

4. The method of claim 1, wherein the determining if the received traffic statistics from the monitor are within the set of acceptable limits or not comprises:
for each parameter of the traffic statistics,
computing an expected value of the parameter based on a set of prior values of the parameter;
computing a ratio between the expected value with an actual value within the received traffic statistics; and
comparing the ratio with the at least one of an upper bound and a lower bound of the ratio.

5. The method of claim 1, wherein the causing the increase in the collection of traffic statistics for that set of traffic flows comprises:
causing the monitor to reduce its interval for collecting traffic statistics for that set of traffic flows.

6. The method of claim 1, wherein the causing the increase in the collection of traffic statistics for that set of traffic flows comprises:
when the set of traffic flows includes more than one traffic flow, selecting a subset from that set of traffic flows, wherein that monitor that was configured to collect traffic statistics for that set of traffic flows is configured to continue the collecting of traffic statistics for the subset of traffic flows; and
configuring one or more new monitors to collect traffic statistics for traffic flows within that set of traffic flows but outside of the subset of traffic flows.

7. The method of claim 1, wherein the causing the reduction in the collection of traffic statistics for that set of traffic flows comprises:
causing the monitor to increase its interval for collecting traffic statistics for that set of traffic flows.

8. The method of claim 1, wherein the causing the reduction in the collection of traffic statistics for that set of traffic flows comprises:
causing the monitor configured for that set of traffic flows to be configured to collect traffic statistics for a merger of that set of traffic flows and another of the sets of traffic flows for which it was determined that the collection of traffic statistics should be reduced; and
causing removal of the monitor that was configured for the other set of traffic flows.

9. An electronic device serving as a software-defined network (SDN) controller coupled to a network containing network elements, wherein traffic flows are transmitted through the network by the network elements, the electronic device comprising:
a processor and a non-transitory machine-readable storage medium coupled to the processor, the non-transitory machine-readable storage medium containing instructions executable by the processor, wherein the electronic device is operative to:
for each of a plurality of sets of traffic flows, cause a monitor to be configured on an identified network element to collect traffic statistics for that set of traffic flows, wherein at least some of the sets of traffic flows include two or more traffic flows that form a traffic aggregate,
instruct the monitors configured on the network devices to collect traffic statistics,
receive the traffic statistics from the monitors,
for each monitor, determine if the received traffic statistics from the monitor are within a set of acceptable limits or not, wherein the set of acceptable limits includes one or more of an upper bound and a lower bound, and
for each of the sets of traffic flows of which the received traffic statistics were determined to be outside of its set of acceptable limits, cause a change in the collection of the traffic statistics for that set of traffic flows, wherein the change is an increase when the upper bound is included and the received traffic statistics are higher than the upper bound, and wherein the change is a reduction when the lower bound is included and the received traffic statistics are lower than the lower bound.

10. The electronic device of claim 9, wherein for determining if the received traffic statistics from the monitor are within the set of acceptable limits or not, the electronic device is further operative to:
for each parameter of the traffic statistics,
compute an expected value of the parameter based on a set of prior values of the parameter;
compute a ratio between the expected value with an actual value within the received traffic statistics; and
compare the ratio with the at least one of an upper bound and a lower bound of the ratio.

11. The electronic device of claim 9, wherein to cause the increase in the collection of traffic statistics for that set of traffic flows, the electronic device is further operative to:
cause the monitor to reduce its interval for collecting traffic statistics for that set of traffic flows.

12. The electronic device of claim 9, wherein to cause the increase in the collection of traffic statistics for that set of traffic flows, the electronic device is further operative to:
when the set of traffic flows includes more than one traffic flow, select a subset from that set of traffic flows, wherein that monitor that was configured to collect traffic statistics for that set of traffic flows is configured to continue the collecting of traffic statistics for the subset of traffic flows; and
configure one or more new monitors to collect traffic statistics for traffic flows within that set of traffic flows but outside of the subset of traffic flows.

13. The electronic device of claim 9, wherein to cause the reduction in the collection of traffic statistics for that set of traffic flows, the electronic device is further operative to:
cause the monitor to increase its interval for collecting traffic statistics for that set of traffic flows.

14. The electronic device of claim 9, wherein to cause the reduction in the collection of traffic statistics for that set of traffic flows, the electronic device is further operative to:
cause the monitor configured for that set of traffic flows to be configured to collect traffic statistics for a merger of that set of traffic flows and another of the sets of traffic flows for which it was determined that the collection of traffic statistics should be reduced; and
cause removal of the monitor that was configured for the other set of traffic flows.

15. The electronic device of claim 10, wherein the electronic device being operative to:
for a monitor instructed an increase of collection of the traffic statistics of the corresponding entry of the monitoring set, find another entry of the monitoring set that is instructed to reduce collection of the traffic statistics, wherein another monitor is assigned to collect traffic statistics of the other entry; and
remove the other monitor from collecting traffic statistics of the other entry, so that the monitor is to be assigned to collect traffic statistics of both the entry and the other entry of the monitoring set.

16. A non-transitory machine-readable medium having instructions stored therein, which when executed by a processor, cause the processor to perform operations at an electronic device serving as a software-defined network (SDN) controller coupled to a network containing network elements, wherein traffic flows are transmitted through the network by the network elements, the operations comprising:
for each of a plurality of sets of traffic flows, causing a monitor to be configured on an identified network element to collect traffic statistics for that set of traffic flows, wherein at least some of the sets of traffic flows include two or more traffic flows that form a traffic aggregate;
instructing the monitors configured on the network elements to collect traffic statistics;
receiving the traffic statistics from the monitors;
for each monitor, determining if the received traffic statistics from the monitor are within a set of acceptable limits or not, wherein the set of acceptable limits includes one or more of an upper bound and a lower bound; and
for each of the sets of traffic flows of which the received traffic statistics were determined to be outside of its set of acceptable limits, causing (220) a change in the collection of the traffic statistics for that set of traffic flows, wherein the change is an increase when the upper bound is included and the received traffic statistics are higher than the upper bound, and wherein the change is a reduction when the lower bound is included and the received traffic statistics are lower than the lower bound.

17. The non-transitory machine-readable medium of claim 16, wherein the determining if the received traffic statistics from the monitor are within the set of acceptable limits or not comprises:
for each parameter of the traffic statistics,
computing an expected value of the parameter based on a set of prior values of the parameter;
computing a ratio between the expected value with an actual value within the received traffic statistics; and
comparing the ratio with the at least one of an upper bound and a lower bound of the ratio.

18. The non-transitory machine-readable medium of claim 16, the causing the increase in the collection of traffic statistics for that set of traffic flows comprises:
causing the monitor to reduce its interval for collecting traffic statistics for that set of traffic flows.

19. The non-transitory machine-readable medium of claim 16, wherein the causing the increase in the collection of traffic statistics for that set of traffic flows comprises:
when the set of traffic flows includes more than one traffic flow, selecting a subset from that set of traffic flows, wherein that monitor that was configured to collect traffic statistics for that set of traffic flows is configured to continue the collecting of traffic statistics for the subset of traffic flows; and
configuring one or more new monitors to collect traffic statistics for traffic flows within that set of traffic flows but outside of the subset of traffic flows

20. The non-transitory machine-readable medium of claim 16, wherein the causing the reduction in the collection of traffic statistics for that set of traffic flows comprises:
causing the monitor to increase its interval for collecting traffic statistics for that set of traffic flows.

21. The non-transitory machine-readable medium of claim 16, wherein the causing the reduction in the collection of traffic statistics for that set of traffic flows comprises:
causing the monitor configured for that set of traffic flows to be configured to collect traffic statistics for a merger of that set of traffic flows and another of the sets of traffic flows for which it was determined that the collection of traffic statistics should be reduced; and
causing removal of the monitor that was configured for the other set of traffic flows.
